(19) United States
(12) Patent Application Publication
(10) Pub. No.: US 2016/0102554 A1
(43) Pub. Date: Apr. 14, 2016

(54) INSPECTION AND QUALIFICATION FOR REMANUFACTURING OF COMPRESSOR WHEELS

(71) Applicant: CATERPILLAR INC., Peoria, IL (US)

(72) Inventor: Sean Olen Cornell, Gridley, IL (US)

(73) Assignee: CATERPILLAR INC., Peoria, IL (US)

(21) Appl. No.: 14/509,911

(22) Filed: Oct. 8, 2014

(51) Int. Cl. F01D 5/00; G01M 15/14; F01D 5/28

(52) U.S. Cl. CPC F01D 5/005; F01D 5/286; G01M 15/14; F05D 2220/40; F05D 2230/80; F05D 2230/90; F05D 2240/24

(57) ABSTRACT

A method for remanufacturing a compressor wheel for a turbocharger is disclosed. The method includes scanning one or more surfaces of the compressor wheel using a laser scanning system to measure a depth of defects located in the one or more surfaces. The method further includes forming a compressive residual stress zone in each of the one or more surfaces with an effective depth that is at least equal to the predetermined distance if all of the measured depths are less than a predetermined distance and discarding the compressor wheel if at least one of the measured depths is greater than or equal to the predetermined distance.

### TECHNICAL FIELD

The present disclosure generally pertains to the remanufacturing of compressor wheels, and is more particularly directed towards the inspection and qualification for the remanufacturing of compressor wheels for turbochargers.

### BACKGROUND

A turbocharger typically includes a compressor and a turbine section. During operation of a turbocharger, the blades for the compressor wheel of the compressor. The compressor wheel may be repaired or remanufactured to effectively extend the service life of the compressor wheel.

U.S. Pat. No. 7,925,454 to A. Narcus discloses a process for determining a remaining useful life for a turbine airfoil that suffers from erosion or corrosion damage in order to reuse a component that still has acceptable remaining life. The process includes the steps of removing the damaged component, scanning the damaged component with an optical scanner such as a white light scanner to produce a 3D solid model of the damaged component, scanning a new component to produce a 3D solid model of the undamaged component, comparing the two 3D solid models to determine the amount of damage on the damaged component, determining the length of time the damaged component was used and the temperature at which it was exposed, and analyzing the 3D solid model of the damaged component to determine how much longer the part can be used before the component will suffer critical damage or the engine will suffer unacceptable performance.

The present disclosure is directed toward overcoming one or more of the problems discovered by the inventors.

### SUMMARY OF THE DISCLOSURE

A method for remanufacturing a compressor wheel for a turbocharger is disclosed. The method includes scanning one or more surfaces of the compressor wheel using a laser scanning system to measure a depth of defects located in the one or more surfaces, the depth of each defect being measured relative to the surface the defect is located in. The method also includes comparing the depth of each defect measured to a predetermined distance. The method further includes keeping the compressor wheel if all of the measured depths are less than the predetermined distance and discarding the compressor wheel if at least one of the measured depths is greater than or equal to the predetermined distance. The method yet further includes forming a compressive residual stress zone in each of the one or more surfaces with an effective depth that is at least equal to the predetermined distance if the compressor wheel is kept.

### BRIEF DESCRIPTION OF THE DRAWINGS

FIG. 1 is a perspective view of the main components of a typical turbocharger.

FIG. 2 is a perspective view of an embodiment of the compressor wheel for the turbocharger of FIG. 1.

FIG. 3 is a side view of an embodiment of the compressor wheel for the turbocharger of FIG. 1 with a portion cut away.

FIG. 4 is a cross-sectional view at a surface of the compressor wheel of FIG. 3.

FIG. 5 is a flowchart of a method for remanufacturing the compressor wheel of FIGS. 1 to 3.

### DETAILED DESCRIPTION

The systems and methods disclosed herein include the use of a laser scanning system to measure the depth of defects, such as pitting, dents, cracks and micro-fractures in the surfaces of a compressor wheel. These defects may form during operation of the turbocharger. The systems and methods disclosed may further include forming a compressive residual stress zone at those surfaces when the depth of the defects are less than the effective depth of the compressive residual stress zone. Use of a laser scanning system may be more cost effective and accurate than other methods, such as ultrasonic inspection and human inspection. Formation of the compressive residual stress zones with an effective depth greater than the depth of the defects may extend the fatigue life and subsequently the operating life of the compressor wheel.

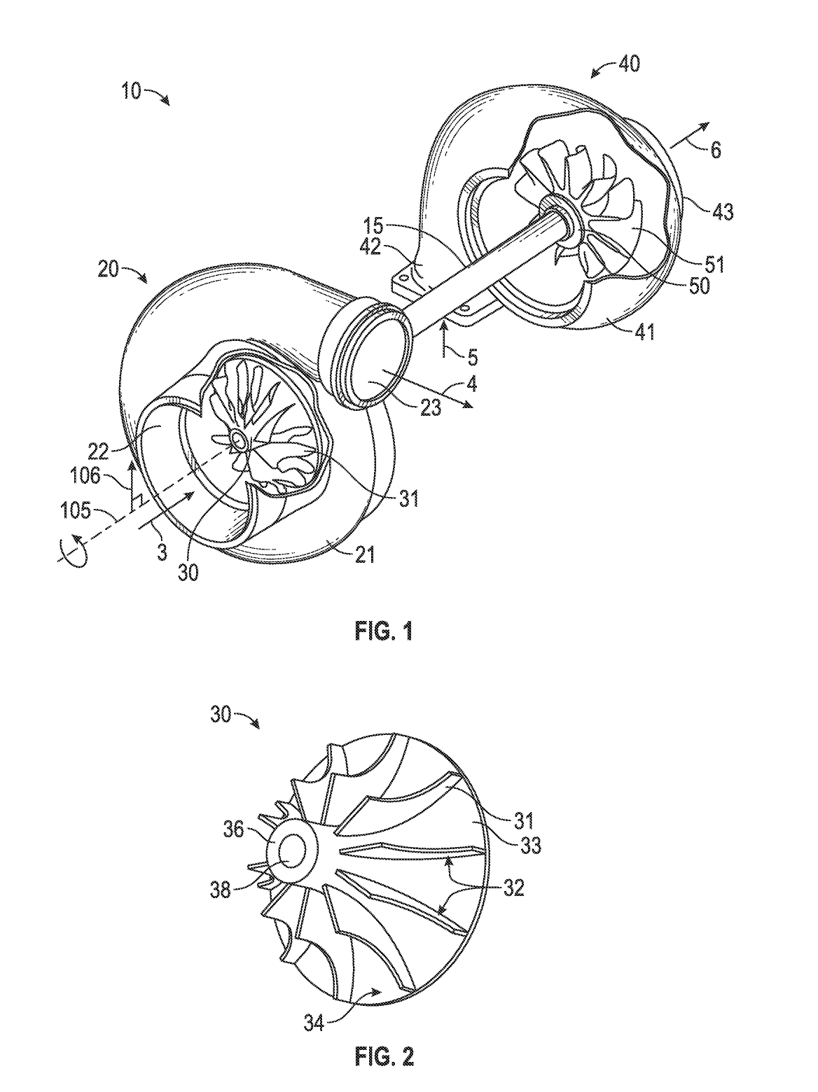

FIG. 1 is a perspective view of the main components of a typical turbocharger 10. Some of the surfaces have been left out or exaggerated for clarity and ease of explanation. Also, the disclosure may generally reference a center axis 105 of rotation of the turbocharger 10, which may be generally defined by the longitudinal axis of its shaft 15. The center axis 105 may be common to or shared with various other concentric components. All references to radial, axial, and circumferential directions and measures refer to center axis 105, unless specified otherwise, and terms such as “inner” and “outer” generally indicate a lesser or greater radial distance from center axis 105, wherein a radial 106 may be in any direction perpendicular and radiating outward from center axis 105.

Turbocharger 10 includes a compressor section 20 and a turbine section 40 connected by a shaft 15. The compressor section 20 includes compressor housing 21 and compressor wheel 30. Compressor housing 21 includes air inlet 22 and air outlet 23. Air inlet 22 may be an axial inlet, while air outlet 23 may extend in a radial or circumferential direction. Compressor wheel 30 is housed within compressor housing 21 and couples to shaft 15. As illustrated, compressor wheel 30 is a radial rotor assembly. Compressor wheel 30 includes multiple compressor airfoils 31, which may be integral to compressor wheel 30.

Turbine section 40 includes turbine housing 41 and turbine rotor 50. Turbine housing 41 includes exhaust inlet 42 and exhaust outlet 43. Exhaust inlet 42 may be a radial or circumferential inlet, while exhaust outlet 43 may be an axial outlet. Turbine rotor 50 is housed within turbine housing 41 and couples to shaft 15. Turbine rotor 50 and compressor wheel 30 may couple to shaft 15 at opposite ends. As illustrated, turbine rotor 50 is a radial rotor assembly. Turbine rotor 50 includes multiple turbine airfoils 51, which may be integral to turbine rotor 50.

FIG. 2 is a perspective view of an embodiment of the compressor wheel 30 for the turbocharger 10 of FIG. 1. Compressor wheel 30 may include a hub 33 and compressor airfoils 31. Hub 33 is the central portion of compressor wheel 30. Hub 33 includes a hub surface 34, a nose 36, and a bore 38. Hub surface 34 may include a shape that extends first in an axial direction then curves outward to a radial direction, such as a pseudosphere or a hyperbolic funnel. Hub surface 34 is configured to redirect air from an axial direction to a radial direction.

Nose 36 may be the narrow portion of hub 33. Nose 36 may include a substantially annular shape. Bore 38 may extend axially through compressor wheel 30 and is configured to secure compressor wheel 30 to shaft 15.

Compressor airfoils 31 may extend radially outward from hub 33. In the embodiment illustrated, compressor airfoils 31 extend normal to hub surface 34. In other embodiments, compressor airfoils 31 may be curved, such as in the circumferential direction. Each compressor airfoil 31 may include an airfoil surface facing generally in each circumferential direction.

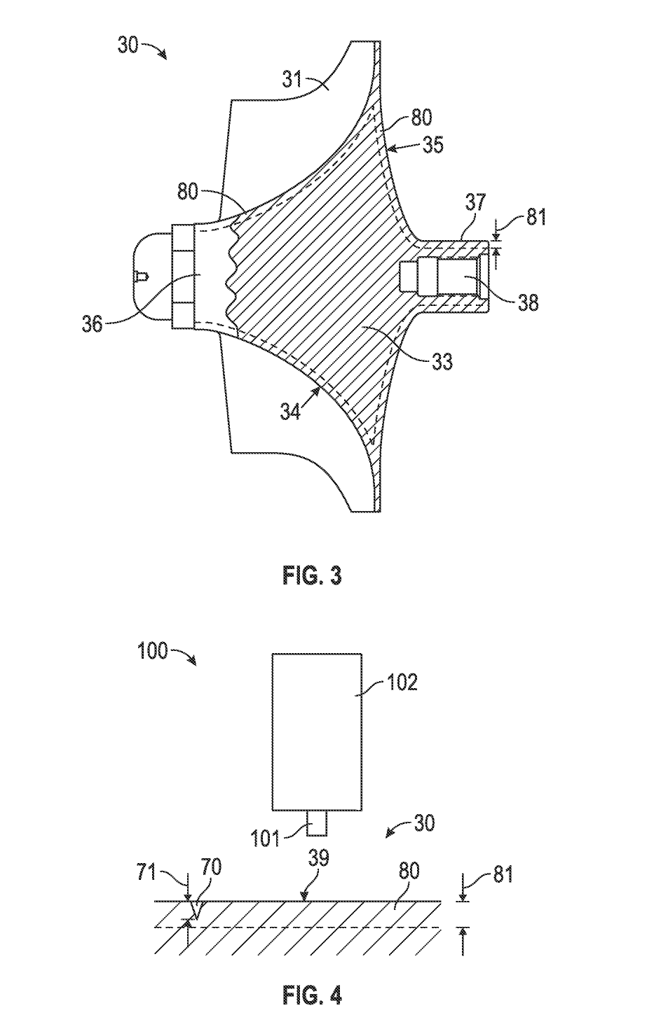

FIG. 3 is a side view of an embodiment of the compressor wheel 30 for the turbocharger 10 of FIG. 1 with a portion cut away. Compressor wheel 30 may also include a stem 37 extending axially from hub 33. Stem 37 may include a cylindrical shape with bore 38 extending there through. Hub 33 may also include a wheel backwall 35. Wheel backwall 35 may be the axially aft facing surface of compressor wheel and may be opposite hub surface 34.

One or more of the above components (or their subcomponents) may be made from aluminum, stainless steel, titanium, titanium alloys and/or superalloys, including nickel based alloys. A superalloy, or high-performance alloy, is an alloy that exhibits excellent mechanical strength and creep resistance at high temperatures, good surface stability, and corrosion and oxidation resistance. In the embodiments discussed above, compressor wheel 30 is formed of an aluminum alloy.

Damaged or worn compressor wheels may be inspected for damage and may be repaired or remanufactured to extend the life of the compressor wheels 30. FIG. 4 is a cross-sectional view at a surface 39 of the compressor wheel 30 of FIG. 3. Surface(s) 39 may be hub surface 34, airfoil surface 32, or wheel backwall 35.

A laser scanning system 100 may be used to inspect and scan the surfaces 39 of compressor wheel 30 for damage, such as defects 70. In embodiments, the laser scanning system 100 may be an optical scanner that is used to perform non-contact surface height measurements of surfaces 39. Laser scanning system 100 may include a body 102 with a laser source 101. In embodiments, the laser source 101 is a white light source.

### INDUSTRIAL APPLICABILITY

Turbochargers may be suited for use in automobiles and in heavy duty vehicles. Turbochargers increase the mass of air supplied to an engine, resulting in improved engine performance. Referring to FIG. 1, exhaust inlet gas 5 enters exhaust inlet 42 of turbine housing 41 and powers (rotates) turbine rotor 50 before exiting exhaust outlet 43 as exhaust outlet gas 6. Turbine rotor 50 drives compressor wheel 30 via shaft 15. Compressor wheel 30 draws ambient air 3 in through air inlet 22. Compressor wheel 30 compresses the air and directs compressed air 4 to air outlet 23. Air outlet 23 may be connected to the engine intake manifold. Compressed air 4 is then directed into the engine intake manifold and used for combustion. The combustion exhaust may be connected to exhaust inlet 42.

Turbochargers 10, including compressor wheels 30, may operate at very high speeds, often up to speeds between 90,000 revolutions per minute to 250,000 revolutions per minute. During operation of turbochargers 10 compressor wheels may be come damaged when defects 70, such as pitting, dents, cracks and micro-fractures, form at the surfaces 39 of compressor wheel 30. Compressor wheels 30 may be forged and machined out of an aluminum block. A forged and machined aluminum compressor wheel 30 may be relatively expensive compared to other aluminum parts. It may be desirable to remanufacture and reuse forged and machined aluminum compressor wheels 30.

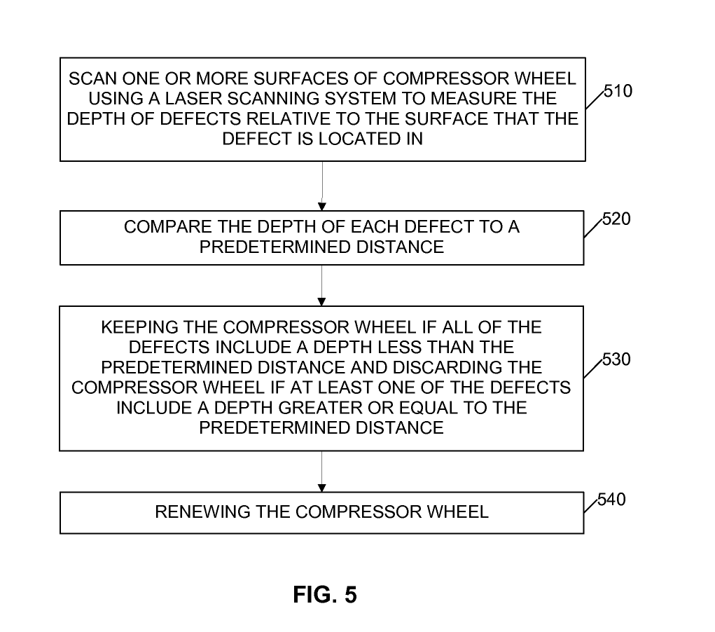

FIG. 5 is a flowchart of a method for remanufacturing the compressor wheel 30 of FIGS. 1 to 4. Referring to FIGS. 3 and 4, the method includes scanning one or more surfaces 39 of compressor wheel 30 using a laser scanning system 100 to measure the depth 71 of defects 70 relative to the surface 39 that the defect 70 is located in at step 510. Step 510 may also include locating one or multiple defects 70 in the one or more surfaces 39 of compressor wheel 30 using the laser scanning system 100. In one embodiment, the laser scanning system 100 may use coherence scanning interferometry to determine the surface topography based on the localization of interference fringes measured during a scan of the surface. The laser scanning system 100 may locate and measure the depths 71 of the defects 70 quicker, more accurately, and more consistently than other measuring methods, such as ultrasonic inspection and human inspection. Each inspector in human visual inspection may qualify defects 70 differently. In another embodiment, the laser scanning system 100 includes an optical system and determines the depth 71 of the defects using focus variation.

Step 510 is followed by comparing the depth 71 of each defect 70 to a predetermined distance at step 520. The method includes keeping the compressor wheel 30 if all of the defects include a depth less than the predetermined distance and discarding the compressor wheel 30 if at least one of the defects 70 include a depth 71 greater or equal to the predetermined distance at step 530. Step 530 may be performed after or simultaneously with step 520.

Step 530 is followed by renewing the compressor wheel 30 at step 540. Renewing the compressor wheel 30 includes forming compressive residual stress zones at one or more surfaces 39 of compressor wheel 30, such as airfoil surface 32, hub surface 34, and wheel backwall 35. In embodiments, the compressive residual stress zones are formed by shot peening the one or more surfaces 39. In other embodiments, the compressive residual stress zones are formed by laser peening the one or more surfaces 39. In yet other embodiments, the compressive residual stress zones are formed by ultrasonic peening the one or more surfaces 39.

The effective depth 81 and the location of where the compressive residual stress zones 80 will be located are illustrated by a dashed line in FIGS. 3 and 4. The effective depth 81 may be equal to or greater than the predetermined distance, and the predetermined distance is equal to or less than the effective depth 81 of the compressive residual stress zones 80. In some embodiments, the predetermined distance is up to 200 microns. In other embodiments, the predetermined distance is up to 150 microns. In yet other embodiments, the predetermined distance is from 145 to 155 microns. In still other embodiments, the predetermine distance is between 100 to 200 microns. In still further embodiments, the predetermined distance is from 125 to 278 microns. In further embodiments, the predetermined distance is 150 microns or approximately 150 microns. In some embodiments, the effective depth is between 150 to 250 microns.

Remanufacturing forged and machined aluminum compressor wheels 30 by forming compressive residual stresses at one or more surfaces 39 of the compressor wheels 30 may improve the fatigue life and operating life of the compressor wheels 30 and may allow the compressor wheels 30 to be reused within a turbocharger 10. In some embodiments, the method includes installing the compressor wheel 30 in the turbocharger 10 after forming the compressive residual stress zones 80 in the compressor wheel 30.

The preceding detailed description is merely exemplary in nature and is not intended to limit the invention or the application and uses of the invention. The described embodiments are not limited to use in conjunction with a particular type of compressor wheel. Hence, although the present disclosure, for convenience of explanation, depicts and describes a compressor wheel for a particular turbocharger, it will be appreciated that the method for remanufacturing compressor wheels in accordance with this disclosure can be implemented in various other configurations, can be used with various other types of turbochargers. Furthermore, there is no intention to be bound by any theory presented in the preceding background or detailed description. It is also understood that the illustrations may include exaggerated dimensions to better illustrate the referenced items shown, and are not consider limiting unless expressly stated as such.

What is claimed is:

1. A method for remanufacturing a compressor wheel for a turbocharger, the method comprising:
scanning one or more surfaces of the compressor wheel using a laser scanning system to measure a depth of defects located in the one or more surfaces, the depth of each of the defects being measured relative to the surface that each of the defects is located in;
comparing the depth of each defect measured to a predetermined distance;
keeping the compressor wheel if all of the measured depths are less than the predetermined distance and discarding the compressor wheel if at least one of the measured depths is greater than or equal to the predetermined distance; and
forming a compressive residual stress zone in each of the one or more surfaces with an effective depth that is at least equal to the predetermined distance if the compressor wheel is kept.

2. The method of claim 1, wherein scanning the one or more surfaces of the compressor wheel to measure the depth of each of the defects located in the one or more surfaces includes locating the defects in the one or more surfaces.

3. The method of claim 1, wherein scanning the one or more surfaces includes scanning a hub surface for a hub of the compressor wheel and scanning an airfoil surface for an airfoil extending from the hub.

4. The method of claim 1, wherein the predetermined distance is between 150 to 200 microns.

5. The method of claim 1, wherein the predetermined distance is up to 150 microns.

6. The method of claim 1, wherein scanning the one or more surfaces of the compressor wheel using the laser scanning system includes scanning the one or more surfaces with a white light source.

7. The method of claim 1, wherein forming the compressive residual stress zone in each of the one or more surfaces includes shot peening the one or more surfaces.

8. The method of claim 1, wherein scanning the one or more surfaces of the compressor wheel using the laser scanning system includes using coherence scanning interferometry to determine the topography of the one or more surfaces based on a localization of interference fringes measured during a scan of the one or more surfaces.

9. The method of claim 1, further comprising installing the compressor wheel in the turbocharger after forming the compressive residual stress zone in each of the one or more surfaces.

10. A method for remanufacturing a forged and machined aluminum compressor wheel for a turbocharger, the compressor wheel including a hub with a hub surface and an airfoil extending from the hub and including an airfoil surface, the method comprising:
scanning the hub surface and the airfoil surface using a laser scanning system to locate a defect in the hub surface and the airfoil surface and to measure a depth of the defect;
comparing the measured depth to a predetermined distance;
forming a compressive residual stress zone in the compressor wheel at the hub surface and at the airfoil surface if the measured depth is less than a predetermined distance, the predetermined distance being equal to or less than an effective depth of the compressive residual stress zone; and
discarding the compressor wheel if the measured depth is greater than or equal to the predetermined distance.

11. The method of claim 10, wherein the effective depth of the compressive residual stress zone is between 150 to 200 microns.

12. The method of claim 10, wherein the predetermined distance is up to 200 microns.

13. The method of claim 10, wherein the predetermined distance is up to 150 microns.

14. The method of claim 10, wherein scanning the hub surface and the airfoil surface using the laser scanning system includes locating multiple defects and measuring the depth of each of the multiple defects.

15. The method of claim 10, wherein scanning the hub surface and the airfoil surface using the laser scanning system includes scanning the hub surface and the airfoil surface with a white light source.

16. The method of claim 10, wherein forming the compressive residual stress zone in the compressor wheel at the hub surface and at the airfoil surface includes shot peening the compressor wheel at the hub surface and at the airfoil surface.

17. The method of claim 10, wherein scanning the hub surface and the airfoil surface using the laser scanning system includes using coherence scanning interferometry to determine a surface topography of the hub surface and the airfoil surface based on a localization of interference fringes measured during a scan of the hub surface and the airfoil surface.

18. The method of claim 10, further comprising installing the compressor wheel in the turbocharger after forming the compressive residual stress zone in the compressor wheel at the hub surface and at the airfoil surface.

19. A compressor wheel remanufactured by scanning surfaces of the compressor wheel with a laser scanning system, determining that defects measured by the laser scanning system include a depth less than a predetermined distance, the compressor wheel comprising:
a hub including a hub surface;
an airfoil extending from the hub, the airfoil including an airfoil surface;
a first compressive residual stress zone formed in the hub at the hub surface; and
a second compressive residual stress zone formed in the airfoil at the airfoil surface, the first compressive residual stress zone and the second residual stress zone each including an effective depth that is greater than or equal to the predetermined distance.

20. The compressor wheel of claim 19, wherein the effective depth is between 150 to 250 microns.
